(19) United States
(12) Patent Application Publication
(10) Pub. No.: US 2016/0055536 A1
(43) Pub. Date: Feb. 25, 2016

(54) PROVIDING OFFERS FOR PURCHASE BASED ON REAL-TIME USER DATA

(71) Applicant: Verizon Patent and Licensing Inc., Arlington, VA (US)

(72) Inventors: Gaurav GUPTA, San Jose, CA (US); Manish SHARMA, San Jose, CA (US); Devin BLONG, Penngrove, CA (US); Kevin FLORES, San Jose, CA (US); Tushar CHAUDHARY, Mountain View, CA (US)

(21) Appl. No.: 14/465,438

(22) Filed: Aug. 21, 2014

(51) Int. Cl. G06Q 30/02

(52) U.S. Cl. CPC G06Q 30/0267; G06Q 30/0261

(57) ABSTRACT

A device may obtain near real-time user data. The near real-time user data may be transmitted by an active application of a user device, and may include information identifying a current geographical location of a user of the user device and information identifying the user. The device may identify offers, for goods or services, relating to the near real-time user data. The device may transmit information regarding a particular offer, of the offers, to the active application to cause the active application to display the information regarding the particular offer. The information regarding the particular offer may be displayed via an interface, of the active application, being used by the user. The interface may provide financial information of the user for purchasing the offer.

### BACKGROUND

A device may receive content, such as advertisements. The advertisements may include textual content, image content, and/or video content. The device may display the advertisements to a user of the device.

### BRIEF DESCRIPTION OF DRAWINGS

FIGS. 1A-1E are diagrams of an overview of an implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for configuring user preferences relating to receiving content;

FIG. 5 is a diagram of an example of the process described with regard to FIG. 4;

FIG. 6 is a flow chart of an example process for providing an offer based on real-time user data;

FIGS. 7A-7F are diagrams of examples of the process described with regard to FIG. 6;

FIG. 8 is a flow chart of an example process for providing an offer based on real-time user data; and

FIGS. 9A-9E are diagrams of examples of the process described with regard to FIG. 8.

### DETAILED DESCRIPTION OF PREFERRED EMBODIMENTS

The following detailed description refers to the accompanying drawings. The same reference numbers in different drawings may identify the same or similar elements.

A device may receive advertisements. The advertisements may include textual content, image content, and/or video content. The device may display the advertisements to a user of the device. However, the content may not be relevant to a current geographical location of the user or may not be relevant to a current activity of the user. Additionally, or alternatively, the advertisements may be provided only via a single application (e.g., a web browser application). Additionally, or alternatively, the user may be required to navigate away from an application or particular content to view the advertisements and/or perform a purchasing transaction relating to the advertisements, thereby disrupting an activity of the user. Furthermore, the user may not easily return to the application or the particular content. Additionally, or alternatively, the advertisements may not be of interest to the user. Additionally, or alternatively, the advertisements may be displayed at a time that is not convenient to the user, thereby disrupting an activity of the user. Accordingly, the experience of the user may not be enhanced or may be negatively affected.

Systems and/or methods described herein may enable information regarding offers (e.g., for goods and/or services) to be identified based on near real-time user data of a user. Systems and/or methods described herein may also provide information regarding an offer (e.g., from the offers) for display via an interface of an application that the user is currently using. Systems and/or methods described herein may also enable a purchasing transaction, relating to the offer, to be performed via the application that the user is currently using.

As used herein, near real-time user data may include information, obtained in real-time or near real-time, that includes information identifying a user, information identifying a device of the user, geographical location information relating to the user, message information relating to the user, search information relating to the user, purchase information relating to the user, browsing information relating to the user, information identifying an active application and/or an inactive application of the device of the user, or the like.

As used herein, an offer may include a financial incentive (e.g., a discount, a rebate, a freebee, or the like), an advertisement, a promotion, and/or another type of marketing information relating to a good and/or a service.

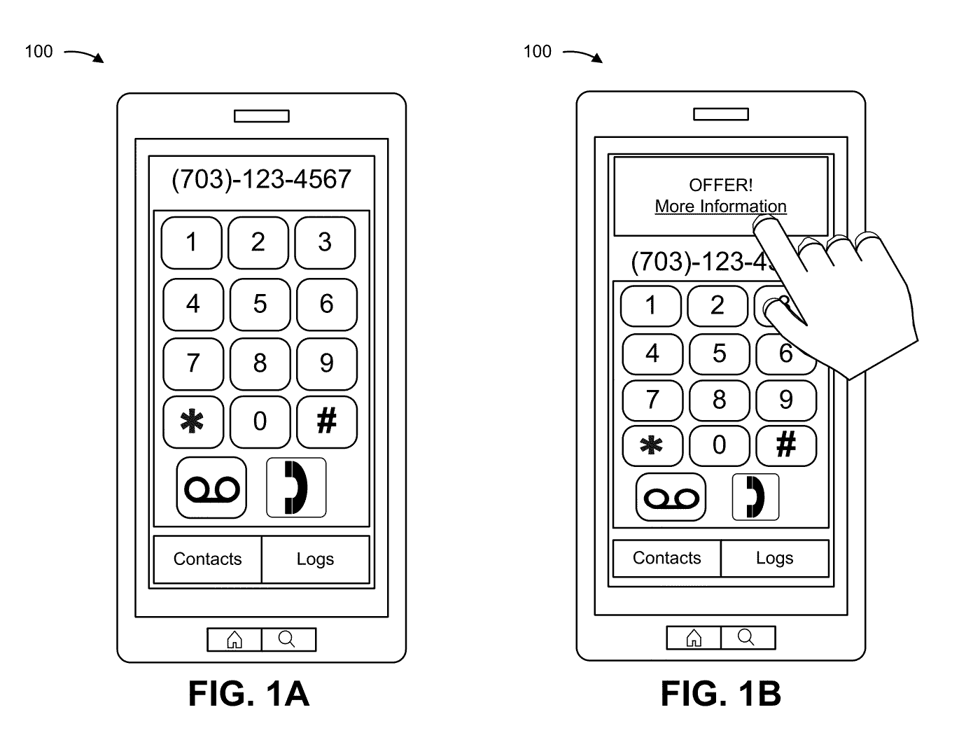

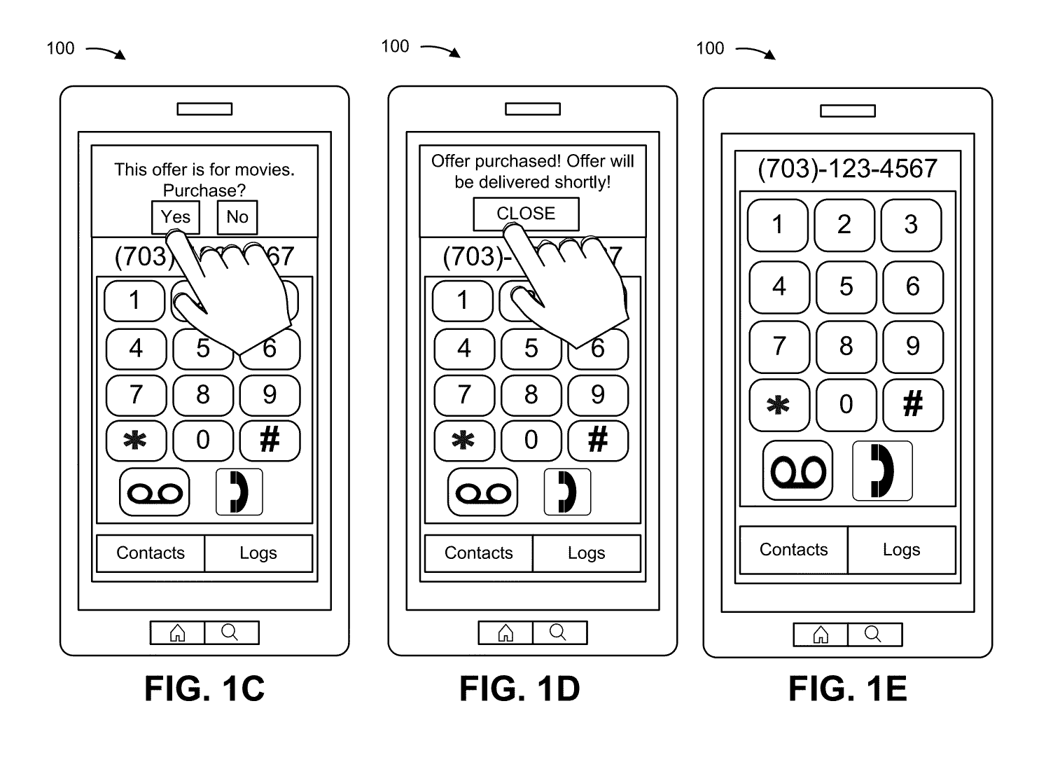

FIGS. 1A-1E are diagrams of an overview of an implementation described herein. As shown in FIG. 1A, assume that a user is using an application (e.g., a dialer application) of a user device (e.g., a smart phone) to place a telephone call. As further shown in FIG. 1A, the application may provide a user interface that enables the user to identify a telephone number for the telephone call. Further, assume that the application is executing a piece of code that causes the application to transmit near real-time user data, of the user, to a content providing device. Further, assume that the content providing device has obtained information regarding an offer relating to the near real-time user data and obtained information indicating that the offer may be provided via the application.

As shown in FIG. 1B, assume that the content providing device has provided the information regarding the offer to the application. As further shown in FIG. 1B, the application may provide the information regarding the offer via the user interface so that the user can view the information regarding the offer without having to navigate away from the application. As further shown in FIG. 1B, the information regarding the offer may include an option to obtain additional information regarding the offer. As shown in FIG. 1B, assume that the user has selected the option to obtain the additional information. As shown in FIG. 1C, the application may provide the additional information via the user interface. As further shown in FIG. 1C, the additional information may include an option to purchase the offer.

As shown in FIG. 1D, assume that the user has selected the option to purchase the offer. As further shown in FIG. 1D, the application may provide, via the user interface, information indicating that the offer has been purchased and that the offer will be delivered to the user (e.g., electronically, such as via e-mail or text messaging, or non-electronically, such as by mail). As further shown in FIG. 1D, the application may provide an option to remove the information regarding the offer from the user interface. As shown in FIG. 1E, assume that the user has selected the option to remove the information regarding the offer. As further shown in FIG. 1E, the application may remove the information regarding the offer and may enable the user to return to identifying a telephone number for the telephone call.

Thus, systems and/or methods described herein may enable information regarding an offer to be identified based on near real-time user data of a user. Systems and/or methods described herein may also provide the information regarding the offer for display via an interface of an application that the user is currently using, and may also enable a purchasing transaction, relating to the offer, to be performed without requiring the user to navigate away from the application that the user is currently using.

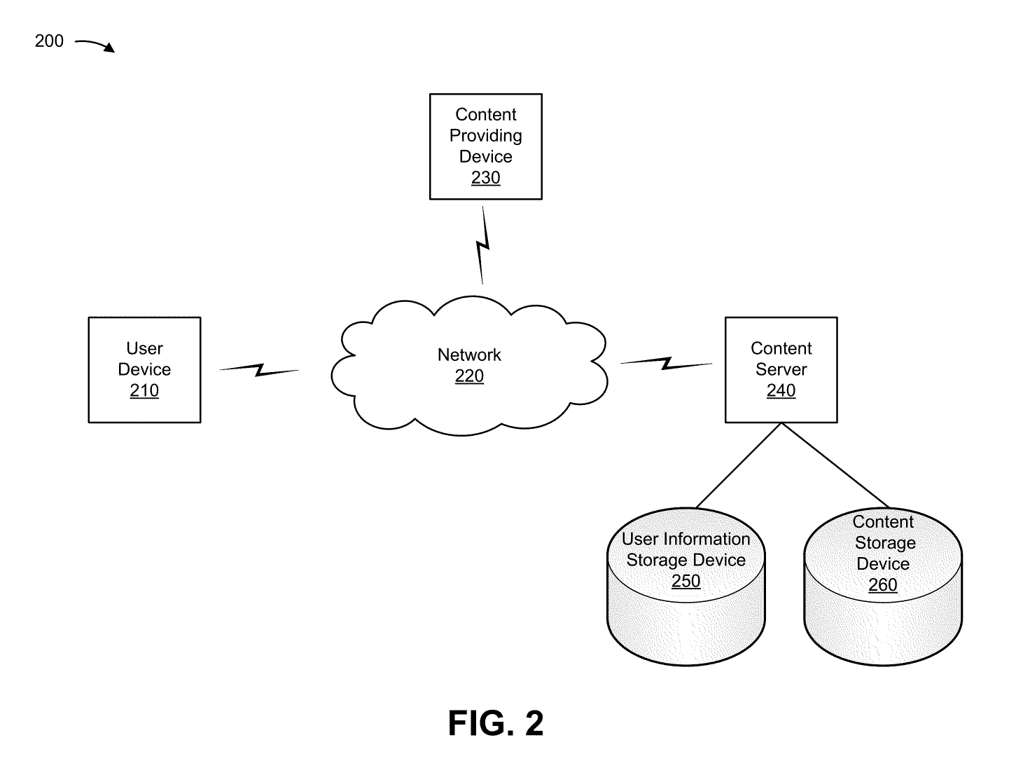

FIG. 2 is a diagram of an example environment 200 in which systems and/or methods described herein may be implemented. Environment 200 may include a user device 210, a network 220, a content providing device 230, a content server 240, a user information storage device 250, and a content storage device 260. The devices of environment 200 may communicate via wired connections, wireless connections, or a combination of wired connections and wireless connections.

User device 210 may include one or more devices that are capable of receiving and displaying information regarding offers. For example, user device 210 may include a smart phone, a desktop computer, a laptop computer, a tablet computer, a gaming device, and/or another type of wired or wireless user device.

Network 220 may include one or more wired and/or wireless networks. For example, network 230 may include a cellular network, a public land mobile network (“PLMN”), a second generation (“2G”) network, a third generation (“3G”) network, a fourth generation (“4G”) network, a fifth generation (“5G”) network, a long term evolution (“LTE”) network, and/or a similar type of network. Additionally, or alternatively, network 230 may include a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, a satellite network, a cloud computing network, and/or a combination of these or other types of networks.

Content providing device 230 may include a server device or a collection of server devices. In some implementations, content providing device 230 may obtain near real-time user data from user device 210, obtain information regarding an offer relating to the near real-time user data from content server 240, and transmit the information regarding the offer to user device 210.

Content server 240 may include one or more server devices. In some implementations, content server 240 may include content providing device 230. In some implementations, content server 240 may receive (e.g., from devices of various entities) and store information regarding offers. Additionally, or alternatively, content server 240 may receive (e.g., from content providing device 230) and store near real-time user data. Additionally, or alternatively, content server 240 may receive (e.g., from content providing device 230) requests for information regarding an offer relating to near real-time user data, obtain the information from content storage device 260, and transmit the information to content providing device 230 and/or user device 210. Additionally, or alternatively, content server 240 may receive (e.g., from user devices of users) and store user information. Additionally, or alternatively, content server 240 may provide marketing code that enables applications (e.g., applications installed on a user device) to transmit near real-time user data and display information regarding an offer relating to the near real-time user data. For example, content server 240 may receive requests for the marketing code from different entities that develop the applications and may provide the marketing code to the different entities for inclusion in the applications.

User information storage device 250 may include one or more storage devices that store information in one or more data structures, such as one or more databases, tables, lists, trees, etc. In some implementations, user information storage device 250 may be included within or otherwise accessible by content server 240. In some implementations, the information may include user information and near real-time user data, such as information identifying users (e.g., names or other identifiers), information identifying devices of the users, location information relating to the users, message information relating to the users, search information relating to the users, purchase information relating to the users, browsing history relating to the users, power state information relating to the user devices, information identifying active applications and/or inactive applications of the user devices, etc. As used herein, an active application may refer to an application that is currently being used by a user, while an inactive application may refer to an application that is not currently being used by the user.

The user information may include information identifying a user, information identifying an opt-in or opt-out with respect to transmitting near real-time user data of the user and receiving content (e.g., information regarding an offer) relating to the near real-time user data, information identifying a frequency relating to providing the content to the user for display, information identifying a period of time (e.g., day, week days, weekend, time, etc.) during which the content may be provided to the user for display, information identifying applications of a user device of the user via which the content is to provided, types of information the user desires to share, contacts of the user, and/or financial information (e.g., information identifying a credit card, a debit card, a bank account, etc.). Additionally, or alternatively, the user information may include demographics of the user, such as age, gender, ethnicity, employment status, income, home ownership, etc. Additionally, or alternatively, the user information may include information identifying types of content of interest to the user.

Location information may include information identifying a current and/or previous geographic location, orientation, velocity of a user determined, for example, by a user device of the user. In some implementations, location information (e.g., associated with the user device) may be used by content server 240 and/or content providing device 230 to predict future location information and to determine, based on a location target criterion, whether the user is and/or will be associated with a target audience for an offer.

Message information may include content (e.g., text, image, sound, video, etc.) and/or metadata (e.g., a sender identifier, recipient identifier, time stamp, etc.), associated with a message, sent to/from the user device using, for example, e-mail, short message service (SMS), multimedia message service (MMS), telephone, video conference, etc. Search information may include content (e.g., a search term, result, etc.) and/or metadata (e.g., a search engine identifier, time stamp, key words, description, quantity of time spent accessing a result, etc.), associated with search queries sent to/from the user device (e.g., to perform a local file search, web-based search, and/or cloud-based search). Purchase information may include information regarding purchases performed by the user. Browsing history may include information regarding browsing activities performed by the user. In some implementations, message information, search information, purchase information, and/or browsing information (e.g., associated with the user device) may be used by content server 240 and/or content providing device 230 to predict a need and/or interest of the user and to determine, based on a need/interest target criterion, whether the user is and/or will be associated with a target audience for an offer.

Power state information may indicate whether the user device, or a component associated with the user device (e.g., a display), is currently on/off/idle. Alternatively, or additionally, power state information may include information associated with interaction between the user device and another user device by, for example, detecting user input or activities associated with user-interaction (e.g., playing audio and/or video), etc. In some implementations, power state information may be used by content server 240 and/or content providing device 230 to predict whether the user is and/or will be likely to interact with the user device when, for example, the user device receives content (e.g., information regarding an offer) from content server 240 and/or content providing device 230.

Content storage device 260 may include one or more storage devices that store information in one or more data structures, such as one or more databases, tables, lists, trees, etc. In some implementations, content storage device 250 may be included within or otherwise accessible by content server 240. In some implementations, the information may be received from devices of various entities (e.g., advertisers). In some implementations, the information may include information regarding offers relating to various goods and/or services. The information regarding the offers may include a description, a location, and/or a cost (e.g., for purchasing goods and/or services) associated with the offers.

Additionally, or alternatively, the information regarding the offers may include information identifying geo-fences relating to providing the information regarding the offers. For example, the information identifying the geo-fences may indicate that an offer is to be provided to users in particular geographical locations and/or geographical areas. Additionally, or alternatively, the information regarding the offers may include information identifying particular periods of time (e.g., date, time, weekday, etc.) relating to providing the offers. For example, the information identifying the particular periods of time may indicate that an offer is to be provided to users at a particular time, on weekdays at a particular time, an amount of time before expiration of the offer, etc. Additionally, or alternatively, the information regarding the offers may include information identifying particular types of users (e.g., based on demographics) relating to providing the information regarding offers. For example, the information identifying the particular types of users may indicate that an offer is to be provided to users of a particular age group, to users with a particular income, to users with a particular interest, etc.

Additionally, or alternatively, the information regarding the offers may include information identifying various rewards (e.g., offers, promotions, and/or discounts relating to goods and/or services) provided to users in exchange for points that users can earn based on interactions with content server 240 and/or content providing device 230. The points may be used to obtain discounts and/or savings on goods and/or services. For example, the information identifying the various rewards may indicate that the more frequently the users interact with content server 240 and content providing device 230 (e.g., to receive marketing information), the more points the users will earn. For instance, the more frequently and/or the higher the quantity of marketing information provided to the users, the more points the users will earn. In some implementations, information regarding points earned by the users may be stored in content storage device 260 and/or user information storage device 250.

The number and arrangement of devices and networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

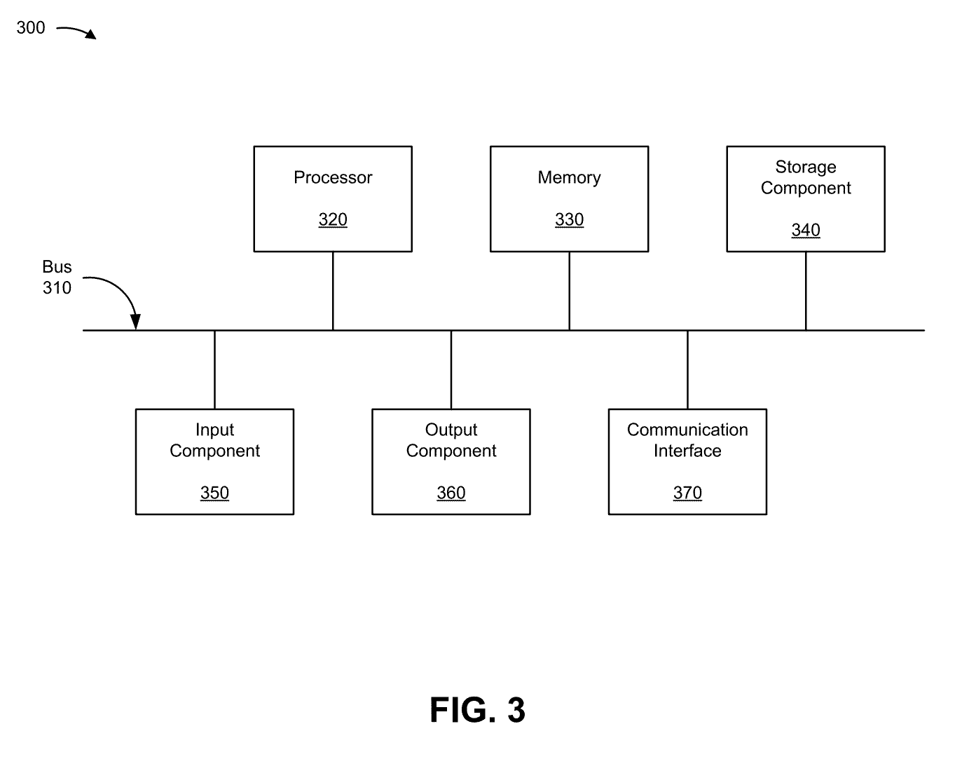

FIG. 3 is a diagram of example components of a device 300. Device 300 may correspond to user device 210, content providing device 230, content server 240, user information storage device 250, and/or content storage device 260. Additionally, or alternatively, each of user device 210, content providing device 230, content server 240, user information storage device 250, and/or content storage device 260 may include one or more devices 300 and/or one or more components of device 300. As illustrated in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit), a microprocessor, and/or any processing logic (e.g., a field-programmable gate array (“FPGA”), an application-specific integrated circuit (“ASIC”), etc.) that interprets and/or executes instructions. Memory 330 may include a random access memory (“RAM”), a read only memory (“ROM”), and/or another type of dynamic or static storage device (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a camera, a microphone, a switch, etc.). Output component 350 may include a component that outputs information from device 300 (e.g., a display, an audio speaker, one or more light-emitting diodes (“LEDs”), etc.).

Communication interface 360 may include a transceiver-like component, such as a transceiver and/or a separate receiver and transmitter that enables device 300 to communicate with other devices, such as via a wired connection, a wireless connection, or a combination of wired and wireless connections. For example, a communication interface 360 may include an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium is defined as a non-transitory memory device. A memory device includes memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3.

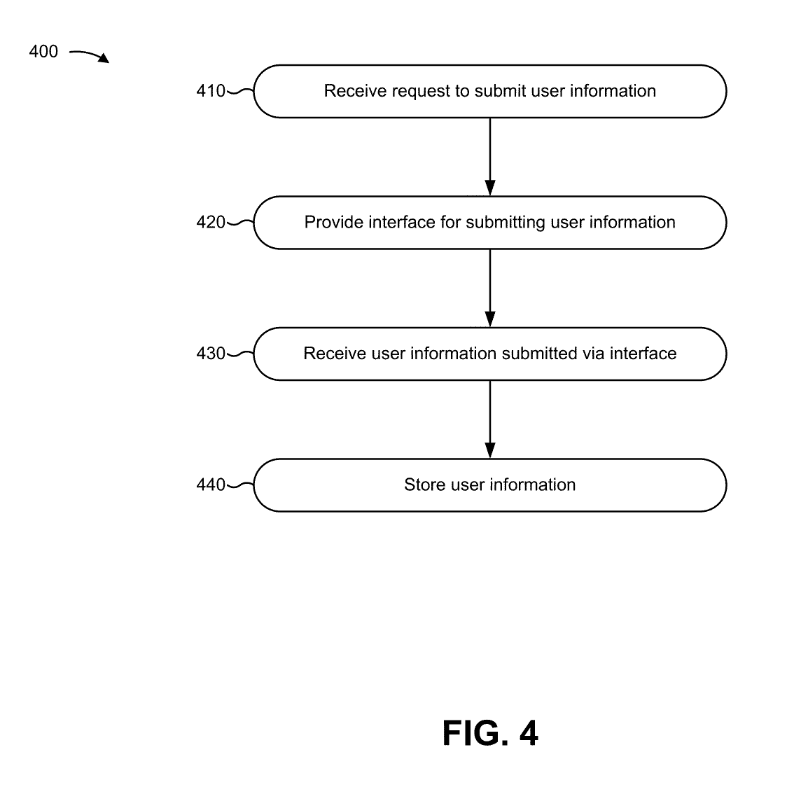

FIG. 4 is a flowchart of an example process 400 for configuring user preferences relating to receiving content. In some implementations, process 400 may be performed by content server 240. In some implementations, one or more process blocks of FIG. 4 may be performed by another device or a group of devices separate from or including content server 240.

As shown in FIG. 4, process 400 may include receiving a request to submit user information (block 410). For example, content server 240 may receive a request, from user device 210, to submit user information of a user of user device 210. For instance, the request may be used as part of the user signing up for services provided by an entity associated with content server 240.

As further shown in FIG. 4, process 400 may include providing an interface for submitting the user information (block 420). For example, based on receiving the request to submit the user information, content server 240 may provide an interface that may enable the user to submit the user information. In some implementations, content server 240 may retrieve, from content storage device 260, the information identifying the various rewards and cause the interface to provide information regarding various rewards. The information identifying the various rewards may be provided to encourage the user to receive information regarding offers. In some implementations, the information identifying the various rewards may identify types of offers associated with highest points (e.g., higher than a threshold) and other types of offers associated with lowest points (e.g., lower than the threshold). Additionally, or alternatively, content server 240 may retrieve, from user information storage device 250, information identifying points (e.g., relating to the various rewards) that the user has earned and cause the interface to provide the information identifying points.

As further shown in FIG. 4, process 400 may include receiving the user information submitted via the interface (block 430). For example, after providing the user interface, content server 240 may receive the user information from user device 210. In some implementations, the user information may include information similar the user information stored in user information storage device 250. For example, the user information may include information identifying the user, information indicating whether the user has opted-in with respect to receiving content (e.g., information regarding offers relating to near real-time user data of the user), information identifying a frequency relating to receiving the content to the user for display, information identifying a period of time (e.g., day, week days, weekend, time, etc.) during which the content may be provided to the user for display, information identifying applications of user device 210 via which the content is to be provided, information identifying types of content of interest of the user, and/or types of information the user desires to share (e.g., as part of near real-time user data of the user). Additionally, or alternatively, the user information may include financial information of the user, demographic information of the user, contacts of the user, or the like.

For example, the information identifying the types of content may include sports related content, traveling related content, food and cooking related content, education related content, religious related content, or the like. The types of information the user desires to share may include information identifying devices of the user (e.g., user device 210), location information relating to the user, message information relating to the user, search information relating to the user, purchase information relating to the user, browsing history relating to the user, power state information relating to the devices, and/or information identifying active applications and/or inactive applications of the devices.

As further shown in FIG. 4, process 400 may include storing the user information (block 440). For example, content server 240 may store the user information in user information storage device 250.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

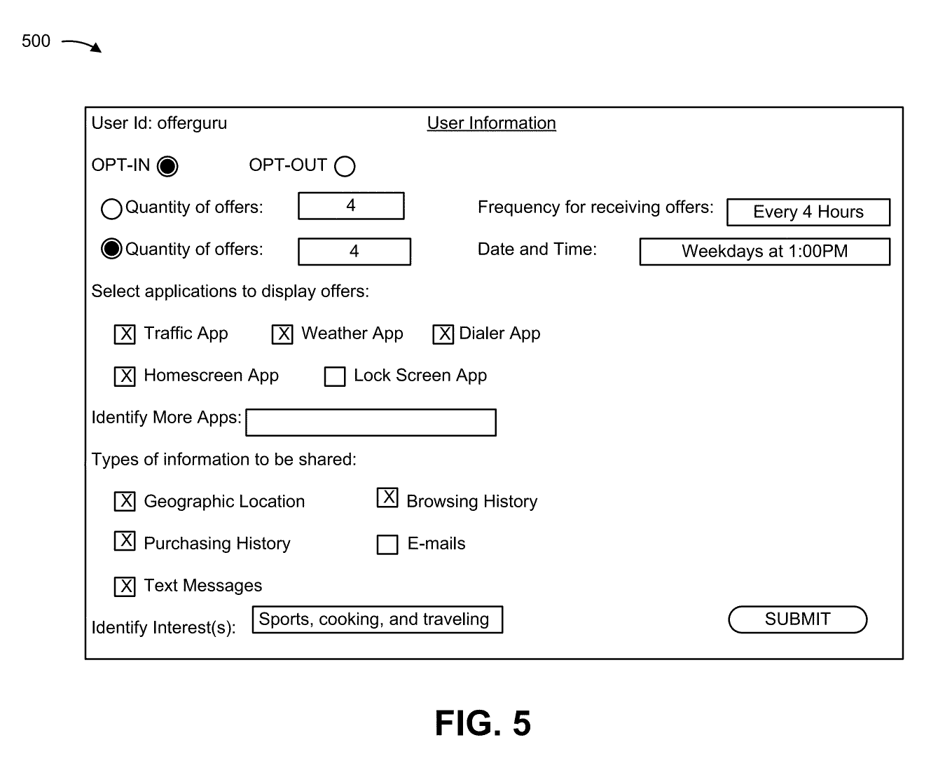

FIG. 5 is a diagram of an example 500 of process 400 described above with respect to FIG. 4. In example 500, assume that a user, associated with user device 210, desires to submit user information and that the user has submitted a request, to content server 240, indicating a desire to submit the user information.

As shown in relation to FIG. 5, content server may cause user device 210 to provide a user interface that allows the user to submit the user information. For example, as shown in relation to FIG. 5, the user interface may include information identifying the user. As further shown in FIG. 5, the user interface may allow the user to indicate whether the user desires to opt-in or opt-out of transmitting near real-time user data of the user and receiving content (e.g., marketing information) relating to the near real-time user data.

As further shown in FIG. 5, the user interface may allow the user to identify a quantity of offers to receive and a frequency relating to providing the offers to the user, or may allow the user to identify a quantity of offers to receive and particular dates and/or times during which the offers may be provided to the user. As shown as an example in FIG. 5, the user may choose to receive four offers weekdays at 1:00 PM (e.g., during lunch time on weekdays).

As further shown in FIG. 5, the user interface may allow the user to identify applications of user device 210 via which the content may be provided to the user. As shown as an example in FIG. 5, the user may identify a traffic application, a weather application, a dialer application, and a homescreen application of user device 210.

As further shown in relation to FIG. 5, the user interface may allow the user to identify the types of information the user desires to share (e.g., as part of near real-time user data). As shown as an example in FIG. 5, the user may indicate that geographic location of the user, browsing information of the user, purchasing information of the user, and text messages of the user may be shared. As further shown in relation to FIG. 5, the user interface may allow the user to identify the types of content of interest to the user (e.g., to be shared as part of near real-time user data). As shown as an example in FIG. 5, the user may identify an interest in sports related content, cooking related content, and traveling related content.

As further shown in relation to FIG. 5, the user interface may allow the user to select a “SUBMIT” option to submit the user information to content server 240.

As indicated above, FIG. 5 is provided merely as an example. Other examples are possible and may differ from what was described with regard to FIG. 5.

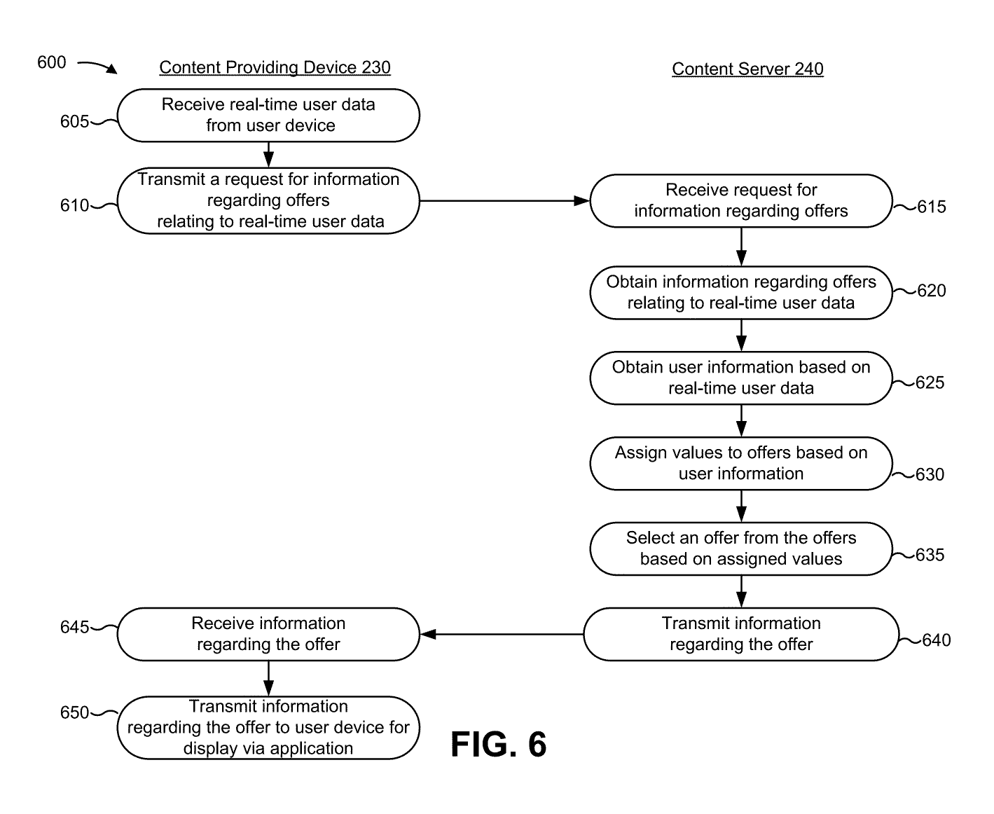

FIG. 6 is a flowchart of an example process for providing an offer based on near real-time user data. In some implementations, process 600 may be performed by content providing device 230 and/or content server 240. In some implementations, one or more process blocks of FIG. 6 may be performed by another device or a group of devices separate from or including content providing device 230 and/or content server 240.

As shown in FIG. 6, process 600 may include receiving near real-time user data from a user device (block 605). For example, content providing device 230 may receive, from user device 210, near real-time user data of a user of user device 210. For instance, the near real-time user data may be received from an active application, of user device 210, executing marketing code. In some implementations, content providing device 230 may receive (or intercept) the near real-time user data when an active application transmits a request for information requested by the active application (e.g., information requested by the user via the active application, information to update the active application, etc.). The request for the active application requested information may be transmitted based on input from the user or may be transmitted independent of the input from the user.

In some implementations, content providing device 230 may receive the near real-time user data based on transmitting a request, to user device 210, for the near real-time user data. For example, content providing device 230 may transmit the request for the near real-time user data based on a trigger, such as a current date and/or time, a network event (e.g., a request from content server 240), or the like. For instance, content providing device 230 may transmit a request, to content server 240, for user information of the user, may obtain the user information, and may identify information identifying a frequency relating to providing the content to user device 210 for display and/or information identifying a period of time (e.g., day, week days, weekend, time, etc.) during which the content may be provided to user device 210 for display. Content providing device 230 may transmit the request for the near real-time user data if the information identifying the frequency and/or the information identifying the period of time corresponds to a current date and/or time and may request the near real-time user data from the active application.

In some implementations, the near real-time user data may include information identifying the user, information identifying user device 210, information identifying the active application, location information relating to the user (e.g., a current and/or previous geographical location of the user), information identifying a current date and/or time, or the like. Additionally, alternatively, the near real-time user data may include the information requested by the active application. Additionally, alternatively, the near real-time user data may include information regarding activities of the user relating to the user using the active application, such as browsing history, search information, purchase information, or the like. Additionally, alternatively, the near real-time user data may include power state information relating to user device 210.

As further shown in FIG. 6, process 600 may further include transmitting a request for information regarding offers relating to the near real-time user data (block 610). For example, after receiving the near real-time user data, content providing device 230 may transmit, to content server 240, a request for information regarding offers relating to the near real-time user data.

As further shown in FIG. 6, process 600 may further include receiving the request for the information regarding the offers relating to the near real-time user data (block 615). For example, content server 240 may receive the request for the information regarding the offers relating to the near real-time user data transmitted by content providing device 230.

As further shown in FIG. 6, process 600 may further include obtaining information regarding the offers relating to the near real-time user data (block 620). For example, content server 240 may obtain the information regarding the offers relating to the near real-time user data based on receiving the request. In some implementations, content server 240 may cause a search of content storage device 260 to be performed for the information regarding the offers based on the near real-time user data (e.g., to identify matches with a portion of the near real-time user data). For example, content server 240 may search content storage device 260 based on the location information. For instance, content server 240 may identify information regarding a first offer based on information identifying geo-fences, of the information regarding the first offer, corresponding to the location information (e.g., within a threshold vicinity of the current and/or previous geographical location, including the current and/or previous geographical location, or the like).

Additionally, or alternatively, content server 240 may search content storage device 260 based on the information identifying the current date and/or time. For instance, content server 240 may identify information regarding a second offer based on particular periods of time, for providing the information regarding the second offer, corresponding to the current date and/or time. Additionally, or alternatively, content server 240 may search content storage device 260 based on the information identifying the active application, the information requested by the active application, and/or the information regarding activities of the user. For instance, content server 240 may identify information regarding a third offer based on the information regarding the third offer corresponding to the information identifying the active application, the active application requested information, and/or the information regarding activities of the user. In some implementations, content server 240 may search content storage device 260 based on interests of the user. For example, content server 240 may determine the interests based on the information identifying the active application, the information requested by the active application, and/or the information regarding activities of the user (e.g., browsing history, search information, purchase information, or the like).

As further shown in FIG. 6, process 600 may further include obtaining user information based on the near real-time user data (block 625). For example, content server 240 may obtain user information of the user from user information storage device 250. In some implementations, content server 240 may cause a search of user information storage device 250 to be performed to identify the user information of the user. For example, content server 240 may search user information storage device 250, based on the information identifying the user (e.g., included in the near real-time user data) to identify and obtain the user information.

As further shown in FIG. 6, process 600 may further include assigning values to offers based on the user information (block 630). For example, after obtaining the user information, content server 240 may assign values to the offers based on the user information. In some implementations, content server 240 may assign values if content server 240 determines that the user information includes information identifying an opt-in with respect to receiving information regarding offers. In some implementations, each of the values may indicate a measure of relevance of a respective offer to the user based on the user information.

In some implementations, content server 240 may assign a value to an offer based on various criteria relating to the user information. The various criteria may include a frequency criterion relating to information identifying a frequency relating to providing the information regarding the offer to the user for display, a time criterion relating information identifying a period of time during which the information regarding the offer may be provided to the user for display, a demographic criterion relating to information regarding demographics of the user, an interest criterion relating to information identifying types of content of interest to the user, and/or an application criterion relating to information identifying applications of user device 210 via which the information regarding the offer is to be provided.

In some implementations, content server 240 may determine a value for each criterion of the various criteria, combine the values determined for the various criteria to obtain a combined value, and assign the combined value to the offer. For example, content server 240 may determine the value for each criterion by comparing the information regarding the offer to each criterion.

In some implementations, each of the determined values may be weighted based on a weight of a respective criterion. In some implementations, a weight of one criterion may differ from a weight of another criterion. For example, a weight of the demographic criterion may exceed a weight of an application criterion to prevent the information regarding the offer from being provided to the user when the demographics of the user do not match a type of users targeted by the offer. Additionally, or alternatively, the weight of the application criterion may exceed a weight of the time criterion and/or the frequency criterion to prevent the information regarding the offer from being provided to an application that is not included in the applications of user device 210 via which the information regarding the offer can be provided.

In some implementations, the weight of a criterion may be determined based on information (e.g., from the user) indicating a measure of importance of the criterion to the user. For example, the user may submit information indicating that the time criterion and/or the frequency criterion are more important than the interest criterion because the user does not desire to be disturbed outside the period of time during which the information regarding the offer may be provided to the user and/or the frequency relating to providing the information regarding the offer. Alternatively, the user may submit information indicating that the interest criterion is more important than any other criterion because the user desires to receive information regarding offers corresponding to the types of content of interest. Additionally, or alternatively, the weight of a criterion may be determined based on historical data, such as information (e.g., from various users) indicating a measure of importance of the criterion to the various users.

While obtaining the information regarding the offers (block 620) and obtaining the user information (block 625) have been described as separate steps, in some implementations, obtaining the information regarding the offers and obtaining the user information may be part of a single step. For example, content server 240 may obtain the information regarding the offers and obtain the user information as part of a single step and may assign the values to the offers based on the information regarding the offers and the user information. For instance, content 240 may assign the values to the offers using a function that takes, as input parameters, the user information and the information regarding the offers and produces, as an output, the values assigned to the information regarding the offers.

As further shown in FIG. 6, process 600 may further include selecting an offer, from the offers, based on the assigned values (block 635). For example, content server 240 may select information regarding an offer based on a value assigned to the offer. In some implementations, content server 240 may select the information regarding the offer when the value, assigned to the offer, exceeds a threshold value. Additionally, or alternatively, content server 240 may select the information regarding the offer when the value exceeds the values assigned to a particular quantity of the offers (e.g., a majority of the offers). For example, content server 240 may select the information regarding the offer when the value is a highest value out of the values assigned to other offers.

As further shown in FIG. 6, process 600 may further include transmitting the information regarding the offer (block 640). For example, content server 240 may transmit the information regarding the offer to content providing device 230 to cause the information regarding the offer to be provided to the active application. In some implementations, content server 240 may transmit the information regarding the offer to an inactive application of user device 210. For example, content server 240 may identify another application from the information identifying applications of user device 210 and may transmit the information regarding the offer to the other application. This may cause the inactive application to provide the information regarding the offer for display to the user (e.g., based on executing the marketing code) when the inactive application becomes an active application. For instance, the inactive application may store the information regarding the offer in a memory associated with user device 210 and may retrieve the information regarding the offer when the inactive application becomes an active application. For instance, when the inactive application becomes an active application, the information regarding the offer may be provided to the user (e.g., via an overlay) via a current interface of the active application.

In some implementations, content server 240 may transmit the information regarding the offer to the active application instead of transmitting the information regarding the offer to content providing device 230. This may cause the information regarding the offer to be provided to the user via a current interface of the active application (e.g., via an overlay).

In some implementations, content server 240 may update points of the user, included in the user information, based on transmitting the information regarding the offer. For example, content server 240 may add points for each application of user device 210 (active application and inactive application) to which the information regarding the offer is transmitted. As explained above, the points may be used to obtain discounts and/or savings on goods and/or services.

As further shown in FIG. 6, process 600 may further include receiving the information regarding the offer (block 645). For example, content providing device 230 may receive the information regarding the offer transmitted by content server 240.

As further shown in FIG. 6, process 600 may further include transmitting the information regarding the offer to the user device for display via the active application (block 650). For example, content providing device 230 may transmit the information regarding the offer to the active application to cause the active application to provide the information regarding the offer based on the active application executing marketing code. For instance, content device 230 may cause the information regarding the offer to be provided via a current interface of the active application (e.g., via an overlay). In some implementations, the information regarding the offer may include information identifying a cost associated with purchasing the offer, information identifying a distance to a location associated with the offer (e.g., a distance, relative the current geographical location of the user, to a location where the offer may be redeemed and/or used), information identifying an address of the location, information identifying a map regarding the location, information identifying an amount of time remaining before the offer expires, information identifying a quantity of similar offers remaining, or the like.

It will be apparent that multiple offers may be obtained based on the near real-time user data and may be provided to the active application for display. While process 600 has been described with respect to offers, process 600 may apply to goods and/or services unrelated to offers.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

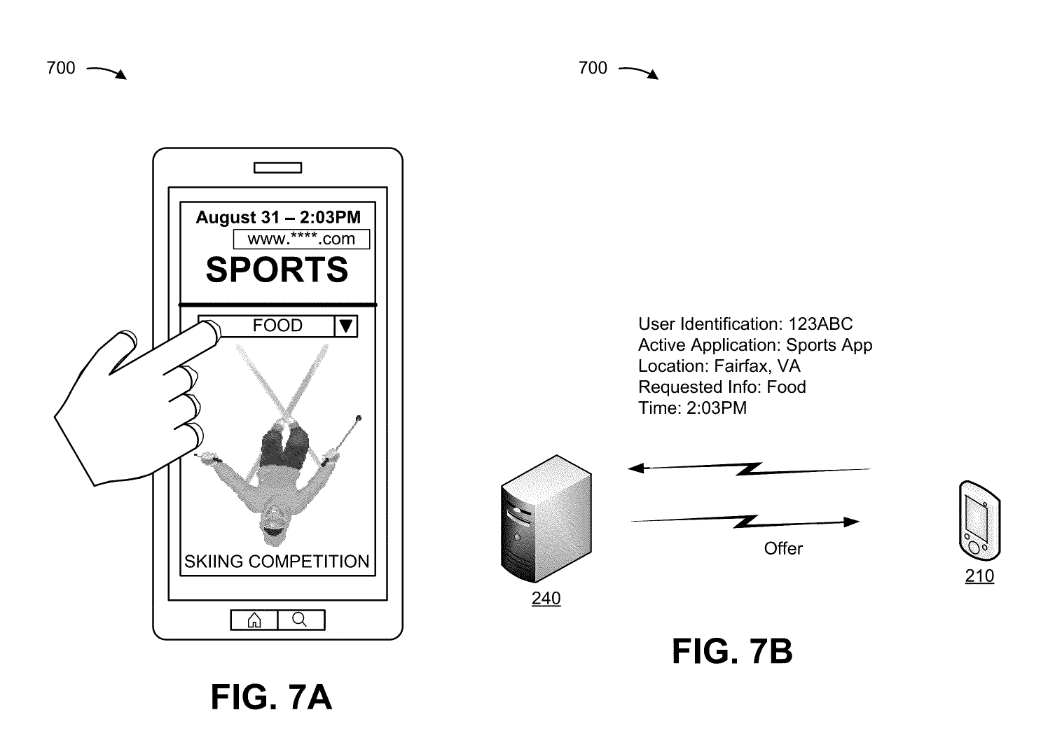

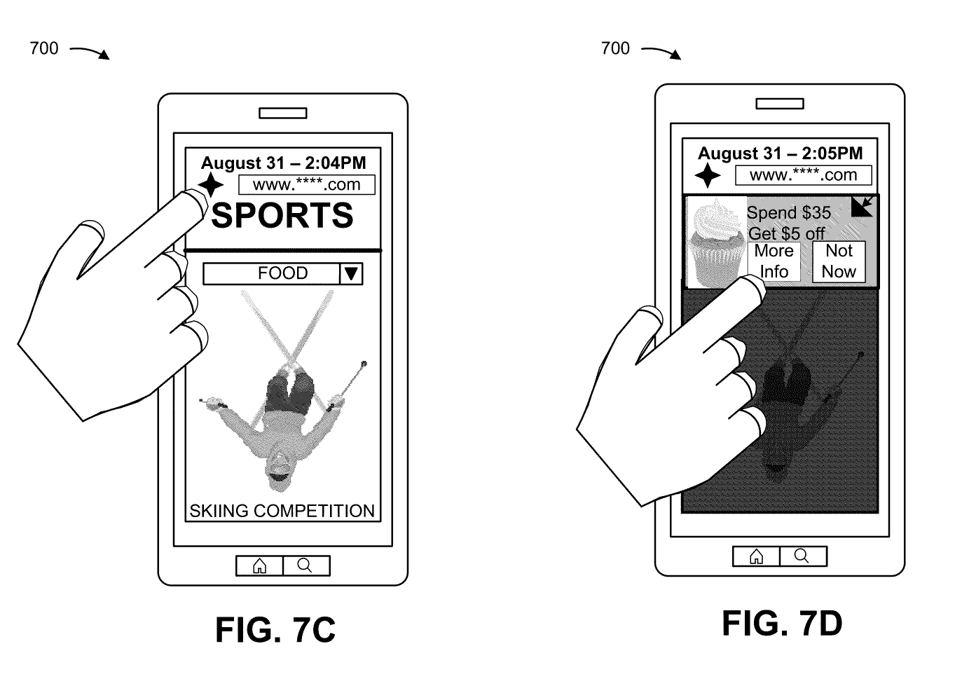

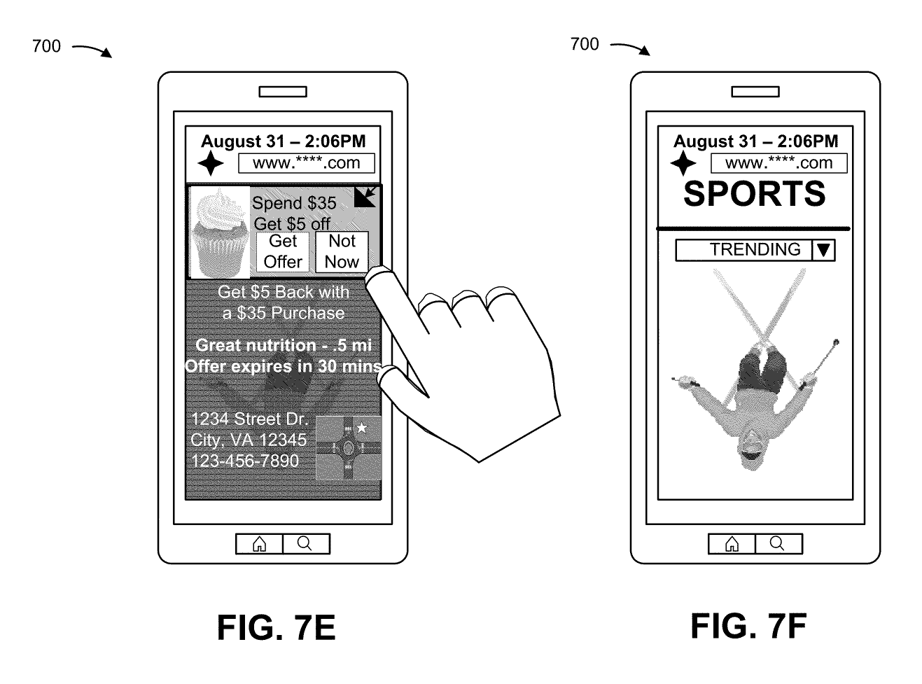

FIGS. 7A-7F are diagrams of an example 700 of process 600 described above with respect to FIG. 6. For the purposes of example 700, assume that a user is using a sports application of user device 210 and that the sports application is executing marketing code. As shown in FIG. 7A, assume that the user of user device 210 requests additional content (e.g., content regarding food). As shown in FIG. 7B, assume that the sports application transmits, via user device 210, a request for the additional content and that the sports application transmits near real-time user data (based on executing marketing code) as part of the request for the additional content. As shown as an example in FIG. 7B, the near real-time user data may include information identifying the user, information identifying the sports application as the active application, information identifying a current geographical location of the user, information identifying food as requested by the active application, and information identifying a current time. As further shown in FIG. 7B, content providing device 230 obtains the near real-time user data, obtains information regarding an offer relating to the near real-time user data from content server 240, and transmits the information regarding the offer to the sports application. For the purposes of example 700, assume that content server 240 has identified the information regarding an offer based on the offer relating to food, the current geographical location corresponding to geo-fence information relating to the offer, and/or user information of the user identifying interests relating to the offer.

As shown in FIG. 7C, assume that the sports application has received the information regarding the offer. As shown as example in FIG. 7C, the sports application may cause (based on marketing code) graphical information (e.g., an icon) to be provided on an interface of the sports application. As shown in FIG. 7C, assume that the user has selected the icon.

As shown as example in FIG. 7D, the sports application may provide the information regarding the offer via the interface. As shown as example in FIG. 7D, the information regarding the offer may include a first button labeled More Info (to enable the user to obtain additional information regarding the offer) and a second button labeled Not Now (to enable the user to remove the information regarding the offer from the interface). As further shown in FIG. 7D, assume the user selects the first button (i.e., the More Info button).

As shown in FIG. 7E, the sports application may provide, via the interface, additional information regarding the offer. As shown as an example in FIG. 7E, the additional information may include information identifying a cost associated with the offer, information identifying a distance (relative to the current geographical location of the user) to a location where the offer may be redeemed or used, information identifying an address of the location, information identifying a map to the location, and information identifying an amount of time remaining before the offer expires. As further shown as an example in FIG. 7E, the additional information may also include a first button labeled Get Offer (to enable the user to purchase the offer) and a second button labeled Not Now (to enable the user to remove the additional information from the interface). As shown in FIG. 7E, assume that the user selects the second button (i.e., the Not Now button).

As shown in FIG. 7F, the additional information regarding the offer may be removed based on the user selecting the second button.

As indicated above, FIGS. 7A-7E are provided merely as an example. Other examples are possible and may differ from what was described with regard to FIGS. 7A-7E.

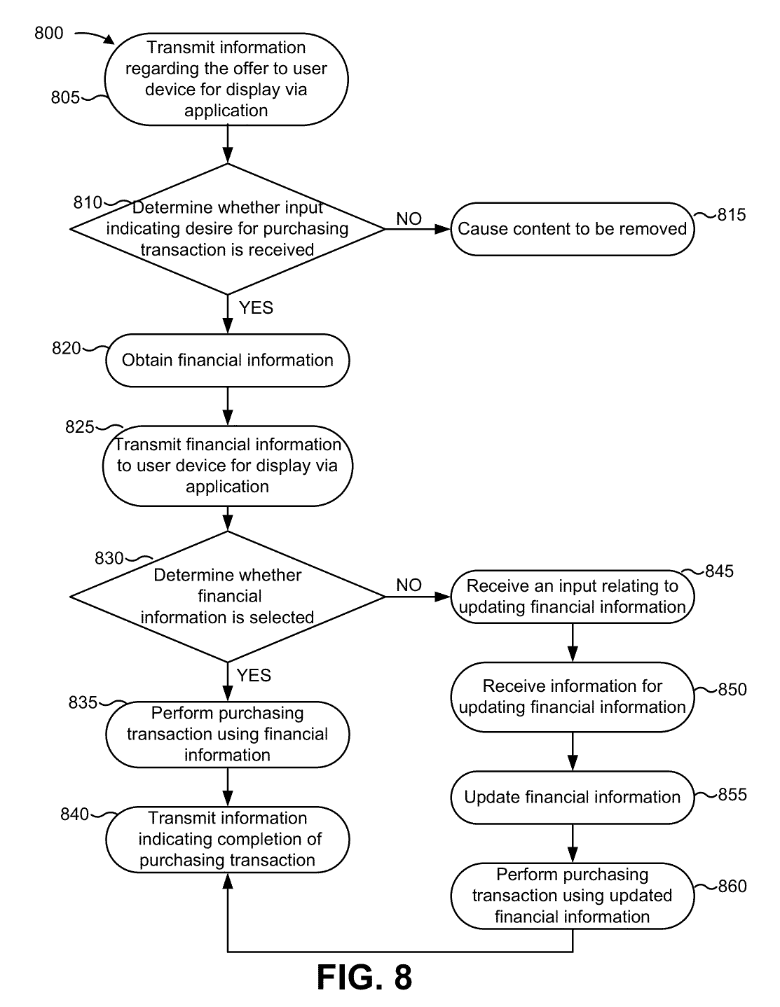

FIG. 8 is a flowchart of an example process for providing an offer based on near real-time user data. In some implementations, process 800 may be performed by content providing device 230. In some implementations, one or more process blocks of FIG. 8 may be performed by another device or a group of devices separate from or including content providing device 230, such as content server 240.

As shown in FIG. 8, process 800 may include transmitting information regarding an offer to a user device for display via an active application (block 805). For example, content providing device 230 may obtain information regarding an offer from content server 240 and transmit the information regarding the offer to an active application of user device 210 for display to a user of user device 210 in a manner similar to that described above with respect to process 600, and more particularly with respect to blocks 680 and 690 of process 600. In some implementations, the information regarding the offer may include information identifying an option for a purchasing transaction relating to the offer and information identifying an option for removing the information regarding the offer from a current interface of the active application.

As shown in FIG. 8, process 800 may further include determining whether input indicating a desire for a purchasing transaction is received (block 810). For example, after transmitting the information regarding the offer to user device 210, content providing device 230 may determine whether the user has submitted an input indicating a desire to obtain the offer (e.g., purchase the offer to obtain the offer or obtain the offer without purchasing the offer, such as a free offer). For instance, content providing device 230 may determine whether the user has selected the option for the purchasing transaction.

As further shown in FIG. 8, if no input indicating a desire for the purchasing transaction has been received (block 810—NO), process 800 may further include causing the information regarding the offer to be removed (block 815). For example, if content providing device 230 determines that the user has not selected the option for the purchasing transaction within a particular amount of time, after the option for the purchasing transaction has been presented, content providing device 230 may determine that the user is not interested in the option for the purchasing transaction. Accordingly, content providing device 230 may cause the information regarding the offer to be removed from the current interface. Additionally, or alternatively, if content providing device 230 determines that the user has selected the option for removing the information regarding the offer from a current interface, content providing device 230 may cause the information regarding the offer to be removed from the current interface.

As further shown in FIG. 8, if an input indicating a desire for the purchasing transaction has been received (block 810—YES), process 800 may further include obtaining financial information of the user (block 820). For example, content providing device 230 may obtain financial information of the user based on receiving the input indicating the desire for the purchasing transaction. In some implementations, content providing device 230 may transmit, to content server 240, a request for the financial information of the user included in user information of the user (e.g., stored on user information storage device 250). For example, content providing device 230 may include, in the request, information identifying the user. The information identifying the user may be obtained from near real-time user data of the user previously obtained by content providing device 230. The request may cause content server 240 to search user information storage device 250 based on the information identifying the user, identify the user information of the user, identify the financial information included in the user information, and transmit the financial information to content providing device 230.

As shown in FIG. 8, process 800 may further include transmitting the financial information to the user device for display via the active application (block 825). For example, content providing device 230 may provide the financial information to the active application for display via the current interface in a manner similar to that described above with respect to block 805 of process 800. In some implementations, the financial information may include information regarding a method of payment last used by the user, a method of payment most used by the user (e.g., exceeding a threshold usage), a method of payment previously used or provided by the user, or the like. In some implementations, content providing device 230 may also provide an option to add another method of payment.

As shown in FIG. 8, process 800 may further include determining whether the financial information is selected (block 830). For example, after transmitting the financial information to user device 210, content providing device 230 may determine whether the user has selected information identifying a particular method of payment (e.g., a particular credit card, a particular debit card, a particular bank account, etc.) identified by the financial information. For instance, content providing device 230 may determine whether an input indicating selection of the information identifying the particular method of payment has been received.

As further shown in FIG. 8, if the financial information has been selected (block 830—YES), process 800 may further include performing the purchasing transaction using the financial information (block 835). For example, content providing device 230 may receive an input indicating that the user has selected the information identifying the particular method of payment and may perform the purchasing transaction using information identifying the particular method of payment. In some implementations, content providing device 230 may transmit the information identifying the particular method of payment to an entity associated with the offer and may cause the entity to debit a cost associated the purchasing transaction. For example, content providing device 230 may cause funds, associated with the particular method of payment, to be transferred to an account (e.g., a monetary account) associated with the entity.

As further shown in FIG. 8, process 800 may further include transmitting information indicating completion of the purchasing transaction (block 840). For example, after completing the purchasing transaction, content providing device 230 may transmit, to the active application, information indicating the completion of the purchasing transaction. This may cause the active application to provide the information to the user via the current interface. In some implementations, content providing device 230 may cause the information to be transmitted to the user electronically (e.g., via a message, such as via a text message, a multi-media message, an e-mail, or the like) and/or non-electronically (e.g., via mail).

In some implementations, the information may include information identifying the offer, the cost associated with the purchasing transaction, information regarding the entity, etc. Additionally, or alternatively, the information may include instructions regarding a manner in which the user may obtain a good and/or a service relating to the purchasing transaction. For example, the information may include instructions regarding a manner in which the offer may be redeemed or used.

In some implementations, content providing device 230 may cause points of the user, included in the user information, to be updated based on completing the purchasing transaction.

As further shown in FIG. 8, if the financial information has not been selected (block 830—NO), process 800 may further include receiving an input relating to updating the financial information (block 845). For example, if the financial information has not been selected, content providing device 230 may receive an input relating to updating the financial information. For instance, content providing device 230 may receive, via the active application, an input indicating that the user desires to add or use a different method of payment based on the user selecting the option to add the other method of payment.

As shown in FIG. 8, process 800 may further include receiving information for updating the financial information (block 850). For example, after receiving the input relating to updating the financial information, content providing device 230 may receive information for updating the financial information. In some implementations, content providing device 230 may cause the active application to provide, via the current interface, an additional interface that enables the user to submit the information for updating the financial information. For example, content providing device 230 may receive, from the active application, the information for updating the financial information submitted by the user via the additional interface. In some implementations, the information for updating the financial information may include information identifying the other method of payment, such as information identifying another credit card, another debit card, and/or another bank account.

As shown in FIG. 8, process 800 may further include updating financial information (block 855). For example, content providing device 230 may transmit the information for updating the financial information to content server 240. This may cause content server 240 to update the financial information, stored in user information storage device 250, using the information for updating the financial information to obtain updated financial information.

As shown in FIG. 8, process 800 may further include performing the purchasing transaction using the updated financial information (block 860). For example, content providing device 230 may perform the purchasing transaction using the information identifying the other method of payment in a manner similar to that described above with respect to block 835. After the purchasing transaction has been performed, process 800 may then proceed to block 840.

It will be apparent that information regarding multiple offers may be obtained based on the near real-time user data and may be provided to the active application for display. While process 800 has been described with respect to offers, process 800 may apply to content unrelated to offers. For example, based on the near real-time user data, content providing device 230 may identify movies, music, books, other goods, services, or the like and may enable the movies, music, books, other goods, services, or the like to be acquired (e.g., purchased, rented, leased, or the like) via the active application.

Although FIG. 8 shows example blocks of process 800, in some implementations, process 800 may include additional blocks, fewer blocks, different blocks, or differently arranged blocks than those depicted in FIG. 8. Additionally, or alternatively, two or more of the blocks of process 800 may be performed in parallel.

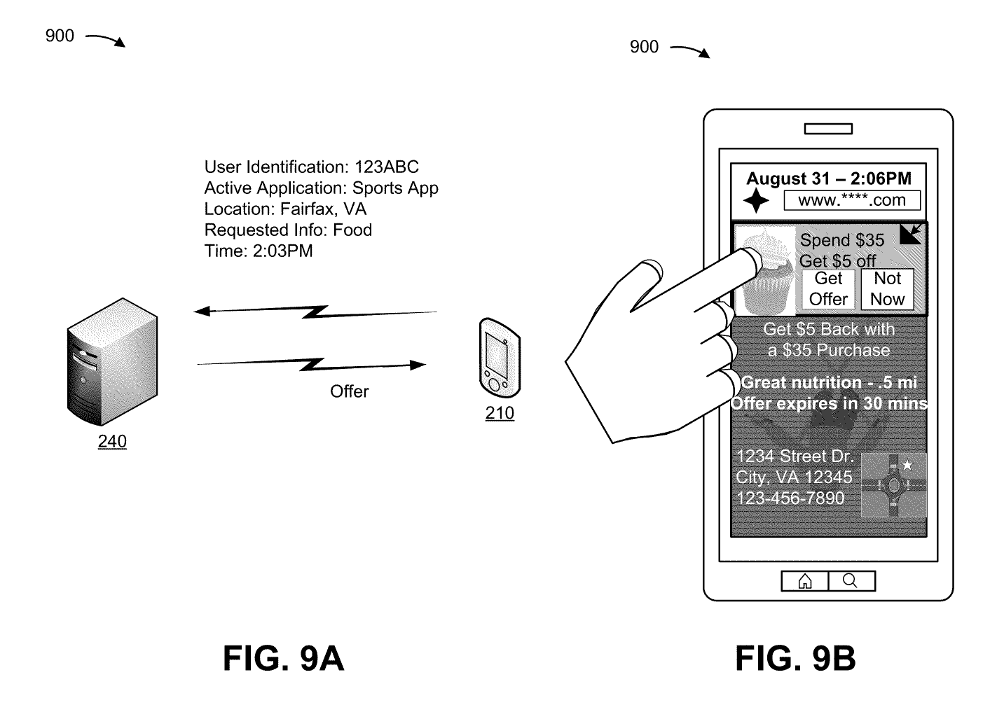

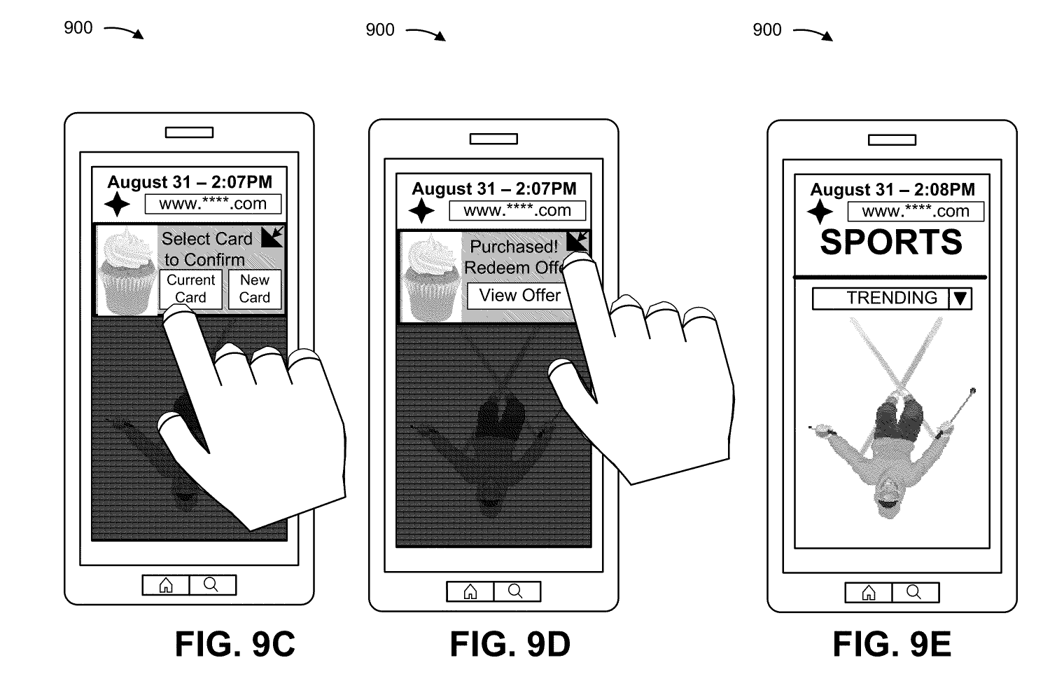

FIGS. 9A-9E are diagrams of an example 900 of process 800 described above with respect to FIG. 8. For the purposes of example 900, assume that a user is using a sports application of user device 210 and that the sports application is executing marketing code in a manner similar to that explained above with respect to FIG. 7A. As shown in FIG. 9A, assume that the sports application transmits near real-time user data as part of a request for additional content in a manner similar to that explained above with respect to FIG. 7B. As further shown in FIG. 9A, assume that content providing device 230 obtains the near real-time user data, obtains advertisements relating to the near real-time user data, and transmits information (regarding an offer relating to the near real-time user data) to the sports application in a manner similar to that explained above with respect to FIG. 7B.

As shown in FIG. 9B, assume that the sports application receives the information regarding the offer. As shown in FIG. 9B, the sports application may provide the information regarding the offer via an interface of the sports application. As shown as example in FIG. 9B, the information regarding the offer may include a first button labeled Get Offer (to enable the user to purchase the offer) and a second button labeled Not Now (to enable the user to remove the information regarding the offer from the interface). As further shown in FIG. 9B, assume the user has selected the first button (i.e., the Get Offer button).

For the purposes of example 900, assume that content providing device 230 has obtained financial information of the user from content server 240 based on information identifying the user (e.g., included in the near real-time user data) and has transmitted the financial information to the sports application. As shown in FIG. 9C, the sports application may provide, via the interface, the financial information of the user. As shown as an example in FIG. 9C, the financial information may be presented as a button labeled Current Card (e.g., a credit card of the user on file). As further shown as an example in FIG. 9C, the sports application may also provide, via the interface, another button labeled New Card to enable the user to add another method of payment. As shown in FIG. 9C, the user may select the button labeled Current Card.

For the purposes of example 900, assume that content providing device 230 receives an input indicating that the user desires to use the credit card on file, and that content providing device 230 performs a transaction to purchase the offer using the credit card. As shown in FIG. 9D, content providing device 230 may transmit, to the active application, information indicating that the offer has been purchased and may cause the active application to display the information to the user.

For the purposes of example 900, assume that the user desires to remove the information indicating that the offer has been purchased and the user has selected a graphical element on the interface to cause the information to be removed. As shown in FIG. 9E, the information regarding the offer may be removed.

As indicated above, FIGS. 9A-9E are provided merely as an example. Other examples are possible and may differ from what was described with regard to FIGS. 9A-9E.

Systems and/or methods described herein may enable content to be identified based on near real-time user data of a user. The content may include information regarding offers relating to goods and/or services and may include information regarding goods and/or services unrelated to offers. Systems and/or methods described herein may also provide the content for display via an interface of an application that the user is currently using, or provide the content to another application for display when the user uses the other application. Systems and/or methods described herein may also enable a purchasing transaction, relating to the content, to be performed via the application that the user is using. Systems and/or methods described herein may also provide the content for display to the user based on user preferences relating to when the content is to be provided for display.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

To the extent the aforementioned implementations collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Certain user interfaces have been described herein and/or shown in the figures. A user interface may include a graphical user interface, a non-graphical user interface, a text-based user interface, etc. A user interface may provide information for display. In some implementations, a user may interact with the information, such as by providing input via an input component of a device that provides the user interface for display. In some implementations, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that example aspects, as described above, may be implemented in many different forms of firmware, hardware, or a combination of hardware and software in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device comprising:
a memory to store instructions; and
one or more processors to execute the instructions to:
receive near real-time user data,
the near real-time user data being received from an active application of a user device,
the near real-time user data including:
information identifying a current geographical location of a user of the user device, and
information identifying the user,
identify a plurality of offers, for goods or services, relating to the near real-time user data,
transmit information regarding a particular offer, of the plurality of offers, to the active application to cause the active application to display the information regarding the particular offer,
the information regarding the particular offer being displayed via an interface, of the active application, being used by the user.

2. The device of claim 1, where the near real-time user data further includes information requested by the active application, and
where, when identifying the plurality of offers, the one or more processors are to:
identify offers relating to the information requested by the active application.

3. The device of claim 1, where, when identifying the plurality of offers, the one or more processors are to:
identify information identifying particular geographical locations or particular geographical areas associated with the plurality of offers,
determine that the current geographical location is included in the particular geographical locations or the particular geographical areas, and
identify the plurality of offers based on determining that the current geographical location is included in the particular geographical locations or the particular geographical areas.

4. The device of claim 1, where the one or more processors are further to:
identify user information of the user based on the information identifying the user, and
identify the information regarding the particular offer based on the user information.

5. The device of claim 4, where the user information includes demographic information of the user, and
where, when identifying the information regarding the particular offer, the one or more processors are further to:
determine that the demographic information corresponds to information identifying types of users associated with the particular offer.

6. The device of claim 1, where the one or more processors are further to:
transmit the information regarding the particular offer to an inactive application to cause the inactive application to display the information regarding the particular offer when the inactive application becomes an active application.

7. The device of claim 1, where the one or more processors are further to:
receive an input indicating a desire to purchase the particular offer,
the input being transmitted by the active application,
obtain, based on receiving the input, financial information of the user,
provide the financial information to the active application for display to the user,
receive another input indicating a desire to use the financial information to purchase the particular offer,
the other input being transmitted by the active application, and
perform a purchase transaction to purchase the particular offer based on receiving the other input.

8. A computer-readable medium storing instructions, the instructions comprising:
one or more instructions which, when executed by one or more processors of a device, cause the one or more processors to:
receive near real-time user data,
the near real-time user data being received from an active application of a user device,
the near real-time user data including:
information identifying a current geographical location of a user of the user device, and
information identifying a current date or time;
identify a plurality of offers relating to goods or services,
the plurality of offers being identified based on the near real-time user data; and
transmit information regarding a particular offer, of the plurality of offers, to the active application to cause the active application to display the information regarding the particular offer to the user,
the information regarding the particular offer being displayed via an interface, of the active application, being used by the user.

9. The computer-readable medium of claim 8, where the one or more instructions to identify the plurality of offers include:
one or more instructions to cause a search to be performed, based on the information identifying the current geographical location and the information identifying the current date or time, to identify the plurality of offers.

10. The computer-readable medium of claim 8, where the near real-time user data further includes at least one of searching information of the user, browsing information of the user, or purchasing information of the user, and
where the one or more instructions to identify the plurality of offers include:
one or more instructions to cause the search to be performed further based on the at least one of the searching information of the user, the browsing information of the user, or the purchasing information of the user.

11. The computer-readable medium of claim 8, where the near real-time user data further includes information identifying the user, and
where the instructions further include:
one or more instructions to identify user information of the user based on the information identifying the user; and
one or more instructions to identify the information regarding the particular offer based on the user information.

12. The computer-readable medium of claim 11, where the user information includes demographic information of the user and information identifying a particular type of content, and
where the one or more instructions to identify the information regarding the particular offer include:
one or more instructions to determine that the demographic information and the information identifying the particular type of content correspond to information included in the information regarding the particular offer.

13. The computer-readable medium of claim 8, where the instructions further include:
one or more instructions to transmit the information regarding the particular offer to an inactive application to cause the inactive application to display the information regarding the particular offer when the inactive application becomes an active application.

14. The computer-readable medium of claim 9, where the near real-time user data further includes information requested by the active application, and
where the one or more instructions to identify the plurality of offers include:
one or more instructions to identify one or more offers relating to the information requested by the active application.

15. A method comprising:
obtaining, by one or more devices, near real-time user data,
the near real-time user data being obtained from an active application of a user device,
the near real-time user data including at least one of:
information identifying a current geographical location of a user of the user device, or
information identifying a current date or time;
identifying, by the one or more devices, a plurality of offers relating to goods or services,
the plurality of offers being identified based on the near real-time user data; and
transmitting, by the one or more devices, information regarding an offer, of the plurality of offers, to the active application to cause the active application to display the information regarding the offer to the user,
the information regarding the offer being displayed via an interface, of the active application, being used by the user.

16. The method of claim 15, further comprising:
transmitting the information regarding the offer to an inactive application to cause the inactive application to display the information regarding the offer when the inactive application becomes an active application.

17. The method of claim 15, further comprising:
receiving an input indicating a desire to purchase the offer,
the input being received from the active application,
obtaining, based on receiving the input, financial information of the user; and
providing the financial information to the active application for display to the user,
the financial information identifying a particular method of payment.

18. The method of claim 17, further comprising:
receiving another input indicating a desire to use the particular method of payment to purchase the offer,
the other input being received from the active application; and
performing a purchase transaction to purchase the offer using the particular method of payment.

19. The method of claim 15, further comprising:
identifying user information of the user based on information identifying the user,
the information identifying the user being included in the near real-time user data; and
identifying the information regarding the offer based on the user information.

20. The method of claim 15, where the near real-time user data further includes information requested by the active application, and
where identifying the plurality of offers includes:
identifying one or more offers relating to the information requested by the active application.
